(19) United States
(12) Patent Application Publication
(10) Pub. No.: US 2013/0004382 A1
(43) Pub. Date: Jan. 3, 2013

(54) APPARATUS FOR GENERATING OZONE WATER

(75) Inventor: George Chen, Taipei City (TW)

(73) Assignee: Xia Men Tahoo System Co., Ltd., Xiamen City, Fujian (CN)

(21) Appl. No.: 13/522,840

(22) PCT Filed: Jan. 18, 2011
(86) PCT No.: PCT/CN2011/000074

§ 371 Date: Sep. 25, 2012

(30) Foreign Application Priority Data
Jan. 18, 2010 (CN) 201010003377.4

(51) Int. Cl. B01J 19/12

(52) U.S. Cl. 422/186.07

(57) ABSTRACT

An ozone water manufacturing device is provided. The ozone water manufacturing device includes a mixer and an ozone generator. The mixer includes a water inlet, a water outlet pipe, a tapered pipe, an importing part and a mixing chamber, wherein the tapered pipe is disposed close to the water inlet, the mixing chamber is disposed close to the water outlet pipe, and the importing part is disposed between the mixing chamber and the tapered pipe. The ozone generator is coupled to the importing part. The mixer disclosed by the present invention can be used to avoid a loss of water pressure, enhance solubility of the ozone, and fully mix water with the ozone.

### BACKGROUND OF THE INVENTION

1. Field of the Invention

The present invention relates to an ozone water manufacturing device, and in particular, but not limited to an ozone water manufacturing device with a mixer.

2. Description of the Related Art

Ozone water has many useful functions, which includes sterilizing, deodorizing, cleaning, and effectively decomposing toxic chemicals and pesticides. It produces no harmful residue after being used, and therefore, may be widely used to gradually replace many chemical agents.

Conventionally, an ozone water manufacturing device mixes water with ozone by using a liquid-gas mixer, while the ozone itself is created through the use of an ozone generator. Ozone and water are separately imported into the mixer in order to form ozone water. The ozone generator may be connected to a pump to forcibly supply air into the ozone generator, The pump can be implemented to push the ozone into the mixer using high pressure. The design ensures a sufficient supply of the ozone, but possible ozone saturation may result in a failure to maintain a satisfactory ozone concentration in the ozone water.

Moreover, the water and the ozone are simultaneously imported into the same mixer to form the ozone water. It is possible that due to insufficient mixing time, the ozone and the water may not evenly mix.

Additionally, in the ozone water manufacturing device, some dead angles can emerge in the pipe that imports water into the mixer, generally due to the changes of a pipe's diameter; such a pipe shape is likely to cause a loss of water pressure, thereby affecting the mixing result of the water and the ozone.

In conclusion, the conventional ozone water manufacturing device utilizes a gas pump to supply ozone, possibly causing ozone saturation. In addition, since water and ozone are simultaneously imported into the same mixer to form the ozone water, possible results in uneven mixing of the ozone and the water may occur. Moreover, when the water is imported into the pipe of the mixer, dead angles are likely to cause a loss of water pressure, thereby affecting the mixing result of the water and the ozone.

### SUMMARY OF THE INVENTION

In view of the foregoing problems, one objective of the present invention is to provide a novel ozone water manufacturing device, where the ozone water manufacturing device does not need to use any pump to forcibly supply air into the ozone generator, thereby avoiding ozone saturation. A mixer in the ozone water manufacturing device is designed to avoid a loss of pressure, enhance solubility of the ozone, and fully mix water with the ozone.

According to the foregoing objective, an embodiment of the present invention discloses an ozone water manufacturing device, where the ozone water manufacturing device includes a mixer and an ozone generator. The mixer includes a water inlet, a water outlet pipe, a tapered pipe, an importing part and a mixing chamber, wherein the tapered pipe is disposed close to the water inlet, the mixing chamber is disposed close to the water outlet pipe, and the importing part is disposed between the mixing chamber and the tapered pipe. The ozone generator is coupled to the importing part.

Compared with a conventional ozone water manufacturing device, the ozone water manufacturing device provided in the present invention has a mixer, which utilizes various components: a water spurt to suck in ozone, thereby avoiding ozone saturation; a tapered pipe to form the water spurt, thereby avoiding a loss of water pressure; and a mixing chamber in order to fully mix the water with the ozone. As a result, the ozone water manufacturing device is able to produce ozone water with a satisfactory ozone concentration, enabling a much wider application scope.

### BRIEF DESCRIPTION OF THE DRAWINGS

The invention will be described according to the appended drawings in which:

FIG. 1 is a schematic diagram of an ozone water manufacturing device according to an embodiment of the present invention;

FIG. 2 is a schematic diagram of a mixer according to an embodiment of the present invention; and

FIG. 3 is a schematic circuit diagram of an ozone water manufacturing device according to an embodiment of the present invention.

### PREFERRED EMBODIMENT OF THE PRESENT INVENTION

In order to better understand the spirit of the present invention, the present invention is further described in the following with reference to exemplary embodiments of the present invention. The present invention aims to provide an ozone water manufacturing device. In order to completely understand the present invention, detailed procedures and compositions are provided in the following description. Evidently, implementation of the present invention is not limited to special details that are well-known by persons skilled in the art related to the ozone water manufacturing device. On the other hand, a well-known composition or procedure is not described in detail in order to avoid unnecessary restrictions to the present invention. The exemplary embodiments of the present invention are described in detail in the following. However, besides the exemplary embodiments that are described in detail herein, the present invention may be further widely implemented in other embodiments. The protection scope of the present invention is subject to the appended claims.

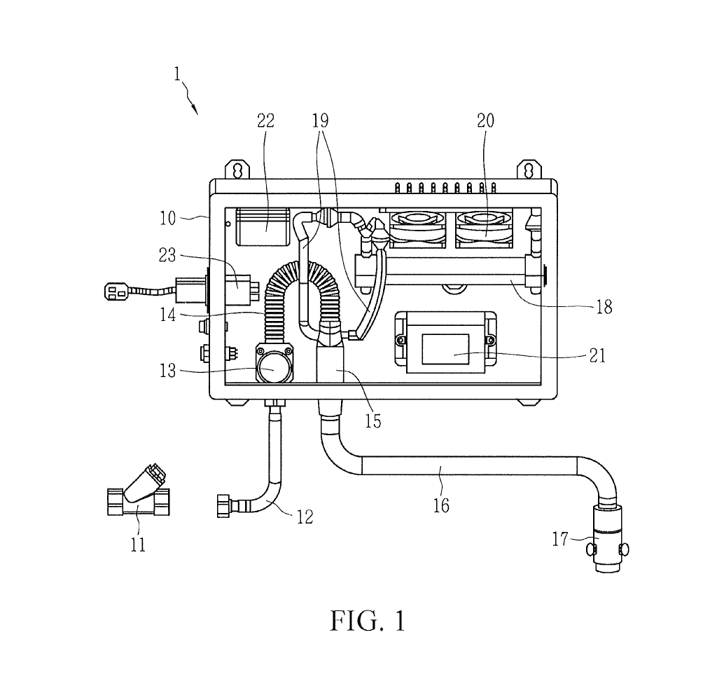

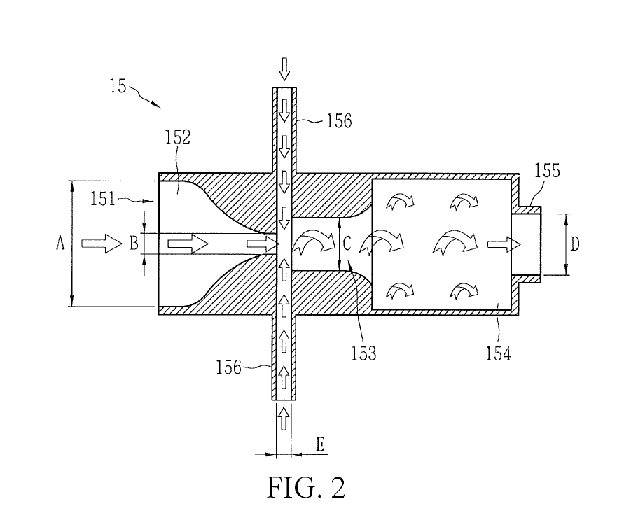

FIG. 1 illustrates an ozone water manufacturing device 1 according to an embodiment of the present invention, and FIG. 2 illustrates a mixer 15 according to an embodiment of the present invention. Referring to FIG. 1 and FIG. 2, the ozone water manufacturing device 1 includes the mixer 15 and an ozone generator 18. The ozone generator 18 is coupled to the mixer 15 through a pipe 19, so that ozone created by the ozone generator 18 may be imported into the mixer 15 to form ozone water. Referring to FIG. 2, the mixer 15 includes a water inlet 151, a water outlet pipe 155, a tapered pipe 152, an importing part 153 and a mixing chamber 154, wherein the tapered pipe 152 is disposed close to the water inlet 151, the mixing chamber 154 is disposed close to the water outlet pipe 155, and the importing part 153 is disposed between the mixing chamber 154 and the tapered pipe 152.

In detail, the ozone generator 18 is coupled to the importing part 151 The tapered pipe 152 has a geometric shape that tapers towards a downstream of a water flow, so as to accelerate a water flow passing through the tapered pipe 152, allowing the water flow to pour into the importing part 153 in a spurt mode, so as to generate a low pressure in the importing part 152. By doing so, ozone created by the ozone generator 18 can be sucked into the importing part 153. Preferably, the geometric shape of the tapered pipe 152 may be designed according to a Witoszynski formula, but the present invention is not limited thereto. The Witoszynski formula is shown as follows:

$$r = \frac{{r}_{*}}{\sqrt{1 - [ 1 - {( \frac{{r}_{*}}{{r}_{0}} )}^{2} \frac{{( 1 - \frac{{x}^{2}}{3 {l}^{2}} )}^{2}}{{( 1 + \frac{{x}^{2}}{{l}^{2}} )}^{3}} ]}}$$

In the foregoing formula, r indicates a radius of an inner edge of the tapered pipe 152, r* indicates a radius of a throat portion of the tapered pipe 152, r₀ indicates a radius of a large pipe mouth end of the tapered pipe 152, 1 indicates a length of the tapered pipe 152, and x indicates a distance from the large pipe mouth end of the tapered pipe 152 to a place of the inner edge whose radius is r.

The tapered pipe 152 designed according to the Witoszynski formula can make the water flow smoothly, so that energy consumption resulting from friction between the water flow and an inner wall of the tapered pipe 152 is reduced, thereby effectively reducing flow resistance and increasing a fluid field. In the tapered pipe 152, designed according to the Witoszynski formula, a velocity field of an outlet of the tapered pipe 152 can be evenly distributed so that the ozone can be dissolved in the water flow more evenly and quickly.

The outlet of the tapered pipe 152 faces the importing part 153. The water flow accelerated by the tapered pipe 152 is poured into the importing part 153, resulting in a reduced pressure in the importing part 153, so that the ozone is sucked from a pipe 156 into the importing part 153. An inner diameter of the importing part 153 may be greater than a diameter of the outlet of the tapered pipe 152. The pipe 156 for importing the ozone may be disposed close to the outlet of the tapered pipe 152, but the present invention is not limited thereto,

The mixing chamber 154 is connected to the importing part 153. Ozone sucked from the importing part 153 and water poured into the importing part 153 enter the mixing chamber 154 after preliminary mixing. The ozone entrained by the poured water flow forms a vortex airflow in the mixing chamber 154, and is further evenly mixed with water, to enhance an ozone dissolution rate. Test results show that the mixer 15, disclosed by the present invention, is capable of generating ozone water with an ozone content ranging from 2.4 mg/L to 3.7 mg/L. In this embodiment, an inner diameter of the mixing chamber 154 may be greater than the inner diameter of the importing part 153 and an inner diameter of the water outlet pipe 155. In particular, an inner diameter A of an inlet of the tapered pipe 152 may range from 15 cm to 25 cm; an inner diameter B of the outlet of the tapered pipe 152 may range from 3 cm to 5 cm; the inner diameter C of the importing part 153 may range from 6 cm to 10 cm; the inner diameter ID of the water outlet pipe 155 may range from 7 cm to 12 cm; the inner diameter E of the pipe 156 may range from 3 cm to 5 cm,

Referring to FIG, 1, the ozone water manufacturing device 1 further includes a shell 10, an electromagnetic switch 13, at least one fan 20, a power supply 21 and a controller 22. The electromagnetic switch 13, the mixer 15, the ozone generator 18, the at least one fan 20, the power supply 21 and the controller 22 are all positioned in the shell 10. The electromagnetic switch 13 is coupled to the water inlet 151 of the mixer 15 through a stainless steel hose 14, and the electromagnetic switch 13 is constructed to control a water flow entering the mixer 15. The at least one fan 20 is constructed to form a forced convection inside and outside of the shell 10, so as to dissipate heat generated by the ozone generator 18 and the power supply 21 inside and outside of the shell 10, so that the ozone water manufacturing device 1 operates below a certain temperature (such as 45° C.). Moreover, in this embodiment, the mixer 15 and the electromagnetic switch 13 in the ozone water manufacturing device 1 may be made of a material including stainless steel.

The power supply 21 is connected to the at least one fan 20, the ozone generator 18, the electromagnetic switch 13 and the controller 22, in order to supply the fan 20, the ozone generator 18, the magnetic switch 13 and the controller 22 with voltages. In an embodiment, the power supply 21 is constructed to transform a 220-volt urban electricity supply (commercial power) into a low voltage DC current for powering the devices, such as the at least one fan 20, the ozone generator 18, the electromagnetic switch 13 and the controller 22. As shown in FIG. 1, on a power line connected to the commercial power, the ozone water manufacturing device 1 may further include a wave filter 23, which is constructed to filter out harmonic waves when AC commercial power is input, so as to prolong the service life of the ozone manufacturing device 18. The wave filter 23 may further include a grounding device (not shown), to avoid short circuits and potential security risks.

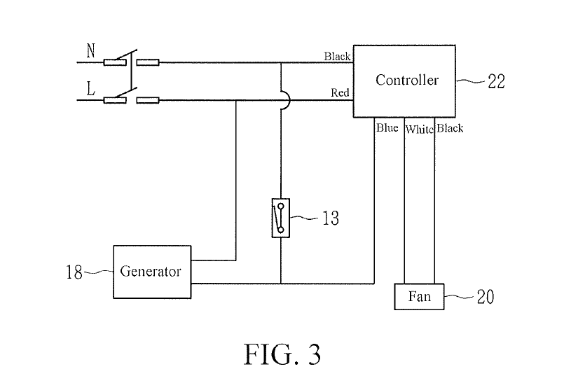

Referring to FIG. 3, the controller 22 may be coupled to the electromagnetic switch 13, the ozone generator 18 and the at least one fan 20. Further, the controller 22 includes a delay switch inside. The advantage of utilizing the delay switch lies in that, the delay switch enables the at least one fan 20 to keep running after the ozone water manufacturing device 1 is shut down, so as to dissipate the accumulated heat in the ozone water manufacturing device 1. Additionally, the controller may also control the automatic startup and shutdown of the ozone manufacturing device 18.

Referring to FIG. 1, the ozone generator 18 may be an isoelectric ozone generator, which utilizes electrode plates that are at a tiny distance apart from each other for the purpose of generating high-energy sparks, and in turn, ionizes oxygen molecules in the air to form ozone molecules with an oxidation reduction potential of 2.07 volts. As mentioned above, currents required by the ozone generator 18 to create ozone are supplied by the power supply 21. Furthermore, the ozone generator 18 may include an air filter (not shown), in which the air filter is capable of filtering air entering the ozone generator 18.

In addition, the electromagnetic switch 13 may be connected to a stainless steel elbow pipe 12, wherein the stainless steel elbow pipe 12 may be connected to a filter 11, so as to filter water entering the ozone water manufacturing device 1. In addition, the water outlet pipe 155 of the mixer 15 may be connected to a stainless steel elbow pipe 16, and a terminal of the stainless steel elbow pipe 16 may be connected to a rotary switch 17, The working principle of the ozone water manufacturing device 1 disclosed by the present invention is as follows: the rotary switch 17 is turned on and a water flow is used to turn on the electromagnetic switch 13; the electromagnetic switch 13 simultaneously turns on the ozone generator 18 and the controller 22; then the controller 22 turns on and turns off the at least one fan 20; the rotary switch 17 is turned off; the manufacturing of the ozone water stops; and the fan is turned off after running for approximately another three minutes.

In conclusion, the ozone water manufacturing device disclosed by the present invention includes a mixer and an ozone generator. The ozone generator is coupled to the mixer to supply ozone. The mixer includes a water inlet, a water outlet pipe, a tapered pipe, an importing part and a mixing chamber, wherein the tapered pipe is disposed close to the water inlet, the mixing chamber is disposed close to the water outlet pipe, and the importing part is disposed between the mixing chamber and the tapered pipe. Incoming water spurts into the importing part through the tapered pipe, sucking ozone from the ozone generator into the importing part. Ozone and water, containing a little ozone, further enter the mixing chamber for mixing, so that the ozone may be fully mixed with the water. The ozone is sucked in by water spurting into the importing part, and no external pressure is used. Therefore, an ozone suction volume may be adjusted with a water volume, thereby ensuring the ozone concentration of the formed ozone water.

The technical contents and technical characteristics of the present invention are disclosed above. However, persons skilled in the art may still make replacements and modifications according to instructions and disclosure based on the present invention without departing from the spirit of the present invention. Therefore, the protection scope of the present invention is not limited to contents disclosed by the embodiments, but should include various replacements and modifications that do not depart from the spirit of the present invention, and is subject to the appended claims.

What is claimed is:

1. An ozone water manufacturing device, comprising:
a mixer, comprising a water inlet, a water outlet pipe, a tapered pipe, an importing part and a mixing chamber, wherein the tapered pipe is disposed close to the water inlet, the mixing chamber is disposed close to the water outlet pipe, and the importing part is disposed between the mixing chamber and the tapered pipe; and
an ozone generator, coupled to the importing part.

2. The ozone water manufacturing device according to claim 1, wherein an inner diameter of the mixing chamber is greater than an inner diameter of the importing part and an inner diameter of the water outlet pipe.

3. The ozone water manufacturing device according to claim 2, wherein a geometric shape of the tapered pipe is designed according to a Witoszynski formula.

4. The ozone water manufacturing device according to claim 3, wherein the ozone water manufacturing device further comprises an electromagnetic switch, wherein the electromagnetic switch is coupled to the water inlet of the mixer.

5. The ozone water manufacturing device according to claim 4, wherein the ozone water manufacturing device further comprises at least one fan, to form a forced convection.

6. The ozone water manufacturing device according to claim 5, wherein the ozone water manufacturing device further comprises a controller; the controller is coupled to the electromagnetic switch, the ozone generator, and the at least one fan, to control operation of the electromagnetic switch, the ozone generator and the at least one fan.

7. The ozone water manufacturing device according to claim 6, wherein the ozone water manufacturing device further comprises a power supply and the power supply is electrically connected to the electromagnetic switch, the ozone generator, the at least one fan, and the controller.

8. The ozone water manufacturing device according to claim 7, wherein the ozone generator further comprises an air filter, to filter air entering the ozone generator.

9. The ozone water manufacturing device according to claim 8, wherein the ozone generator is an isoelectric ozone generator.

10. The ozone water manufacturing device according to claim 9, wherein the mixer is made of a material comprising stainless steel.
